(19) United States
(12) Patent Application Publication
(10) Pub. No.: US 2022/0326165 A1
(43) Pub. Date: Oct. 13, 2022

(54) RAPID X-RAY RADIATION IMAGING SYSTEM AND MOBILE IMAGING SYSTEM

(71) Applicant: JST Power Equipment, Inc., Lake Mary, FL (US)

(72) Inventor: Haoning Liang, Beijing (CN)

(21) Appl. No.: 17/314,003

(22) Filed: May 6, 2021

Related U.S. Application Data
(63) Continuation of application No. PCT/CN2021/085791, filed on Apr. 7, 2021.
Application No. PCT/CN2021/085791 is a continuation of application No. PCT/CN2021/085792, filed on Apr. 7, 2021.

(51) Int. Cl. G01N 23/04; G01N 23/083; G01N 23/18

(52) U.S. Cl. CPC G01N 23/04; G01N 23/083; G01N 23/18; G01N 2223/04; G01N 2223/3306; G01N 2223/3307; G01N 2223/40; G01N 2223/501; G01N 2223/646

(57) ABSTRACT

An X-ray radiation imaging system is for imaging a tubular object. The X-ray radiation imaging system may include an enclosure, a motorized base to be positioned within the enclosure and configured to rotate the tubular object, and a gantry within the enclosure. The X-ray radiation imaging system may further include an X-ray source coupled to the gantry and being adjacent the motorized base. The X-ray source may be configured to irradiate the tubular object with X-ray radiation while the motorized base rotates the tubular object. The X-ray radiation imaging system may also include an X-ray detector coupled to the gantry and being adjacent the tubular object, and the X-ray detector may receive the X-ray radiation from the tubular object. The X-ray radiation imaging system may include a processor coupled to the X-ray source and the X-ray detector and configured to generate an image of the tubular object.

### RELATED APPLICATIONS

This application is a continuation of PCT application serial nos. PCT/CN2021/085791, PCT/CN2021/085792, both filed Apr. 7, 2021, which are hereby incorporated herein in its entirety by reference.

### TECHNICAL FIELD

The present disclosure relates to the field of power transmission, and, more particularly, to power transformers and related methods.

### BACKGROUND

The modern power transmission system is a network connecting power plants to geographically remote large and small loads. Generally, the power transmission system comprises a power plant generating the power to be distributed, and a network of high voltage power transmission lines transmitting the power from the power plant to the remote geographic area where the loads exist. Once in the area, the power transmission system comprises a plurality of substations for respective regions. Each substation comprises step down transformers and switchgear equipment to route and convert the high voltage power signal (i.e. >115,000 VAC) to a medium voltage power signal (i.e. 2,400-69,000 VAC).

From that point, the power transmission system comprises medium voltage power transmission lines and low voltage power transmission lines, which transmit the power to the smaller loads. Of course, there are additional step-down transformers for the low voltage loads (i.e. 240-600 VAC), which include all residential and typical commercial applications. Since it is much more efficient to transmit power at high and medium voltages, the power transmission system necessarily comprises a large number of transformers located close to the smaller loads.

A typical transformer, regardless of voltage level, comprises a magnetic core, and sets of electrically conductive windings surrounding the magnetic core. The electrically conductive windings need to be electrically insulated from adjacent windings. Also, due to the operational power level of the transformers in the power transmission system, there is a desire to thermally cool the transformers. In one application, the windings and the magnetic core are immersed in dielectric oil (e.g. mineral oil). Although the thermal conductivity performance of these immersed transformers is good, when these transformers fail, the event may be problematic, due to the flammable nature of the dielectric oil. Moreover, in substations, there may be several adjacent components, which can be damaged.

To prevent these failures, dielectric oil transformers must be serviced and replaced on a recommended schedule. Another alternative approach is the cast resin transformer. In this approach, rather than dielectric oil, the electrically conductive windings are encased in a dielectric resin. Although the dielectric resin does not need to be serviced, the resin does provide less thermal dissipation than oil immersed transformers. Moreover, the cast resin transformer is not easily repairable.

### SUMMARY

Generally, an X-ray radiation imaging system is for imaging a tubular object (e.g. a cast resin transformer). The X-ray radiation imaging system may include an enclosure, a motorized base to be positioned within the enclosure and configured to rotate the tubular object and a gantry within the enclosure. The X-ray radiation imaging system may further include at least one X-ray source coupled to the gantry and being adjacent the motorized base. The at least one X-ray source may be configured to irradiate the tubular object with X-ray radiation while the motorized base rotates the tubular object. The X-ray radiation imaging system may also include at least one X-ray detector coupled to the gantry and being adjacent the tubular object, and the at least one X-ray detector may receive the X-ray radiation from the tubular object. The X-ray radiation imaging system may include a processor coupled to the at least one X-ray source and the at least one X-ray detector and configured to generate an image of the tubular object.

In particular, the X-ray radiation imaging system may also include at least one detector arm coupled between the gantry and the at least one X-ray detector, and at least one source arm coupled between the gantry and the at least one X-ray source. The processor may be configured to cause the at least one detector arm and the at least one source arm to respectively align the at least one X-ray detector and the at least one X-ray source with respect to the tubular object. The at least one detector arm and the at least one source arm may be configured to extend vertically and simultaneously with equal alignment.

In some embodiments, the at least one X-ray detector may comprise a plurality of X-ray detectors spaced annularly with respect to the tubular object, and the at least one X-ray source may comprise a plurality of X-ray sources spaced annularly with respect to the tubular object and respectively opposite the plurality of X-ray detectors. In other embodiments, the at least one X-ray detector and the at least one X-ray source may be aligned along a tangent of the tubular object.

More specifically, the at least one X-ray detector may comprise a line scanner X-ray detector. The X-ray radiation imaging system may further comprise a conveyor extending through the enclosure and to position the tubular object on the motorized base. For example, the enclosure is opaque to X-ray radiation. Also, the motorized base may comprise an automated guided trolley (AGV).

Another aspect is directed to a method for making an X-ray radiation imaging system for imaging a tubular object. The method may include positioning a motorized base within an enclosure and configured to rotate the tubular object, positioning a gantry within the enclosure, and coupling at least one X-ray source to the gantry and being adjacent the motorized base. The at least one X-ray source may be configured to irradiate the tubular object with X-ray radiation while the motorized base rotates the tubular object. The method may comprise coupling at least one X-ray detector to the gantry and being adjacent the tubular object, the at least one X-ray detector to receive the X-ray radiation from the tubular object, and coupling a processor to the at least one X-ray source and the at least one X-ray detector and to generate an image of the tubular object.

### BRIEF DESCRIPTION OF THE DRAWINGS

FIG. 1 is a schematic diagram of a first embodiment of an X-ray radiation imaging system, according to the present disclosure.

FIG. 2 is a schematic top view diagram of the X-ray radiation imaging system of FIG. 1.

FIG. 3 is a schematic top view diagram of a second embodiment of the X-ray radiation imaging system, according to the present disclosure.

FIG. 4 is a schematic top view diagram of a third embodiment of the X-ray radiation imaging system, according to the present disclosure.

FIG. 5 is a schematic top view diagram of a fourth embodiment of the X-ray radiation imaging system, according to the present disclosure.

FIG. 6 is a schematic side view diagram of a motorized base from the X-ray radiation imaging system of FIG. 5.

FIGS. 7A and 7B are schematic side view diagrams of a motorized base from a fifth embodiment of the X-ray radiation imaging system in retracted and lifted positions, respectively, according to the present disclosure.

FIG. 8 is a schematic top view diagram of a sixth embodiment of the X-ray radiation imaging system, according to the present disclosure.

FIG. 9 is a schematic diagram of a first example embodiment of an X-ray radiation imaging system, according to the present disclosure.

FIG. 10 is a schematic diagram of an X-ray sensing element from the X-ray radiation imaging system of FIG. 9.

FIG. 11 is a flowchart illustrating a method of operating the X-ray radiation imaging system of FIG. 9.

FIG. 12 is a schematic diagram of a second example embodiment of the X-ray detector from the X-ray radiation imaging system of FIG. 9.

FIG. 13 is a schematic diagram of a third example embodiment of the X-ray detector from the X-ray radiation imaging system of FIG. 9.

FIG. 14 is a schematic diagram of a fourth example embodiment of the X-ray detector from the X-ray radiation imaging system of FIG. 9.

FIG. 15 is a schematic diagram of a fifth example embodiment of the X-ray detector from the X-ray radiation imaging system of FIG. 9.

FIG. 16 is a schematic diagram of a sixth example embodiment of the X-ray radiation imaging system of FIG. 9.

FIG. 17 is a flowchart illustrating a method of detecting defects in a cast resin transformer using an example embodiment of the X-ray radiation imaging system of FIG. 9.

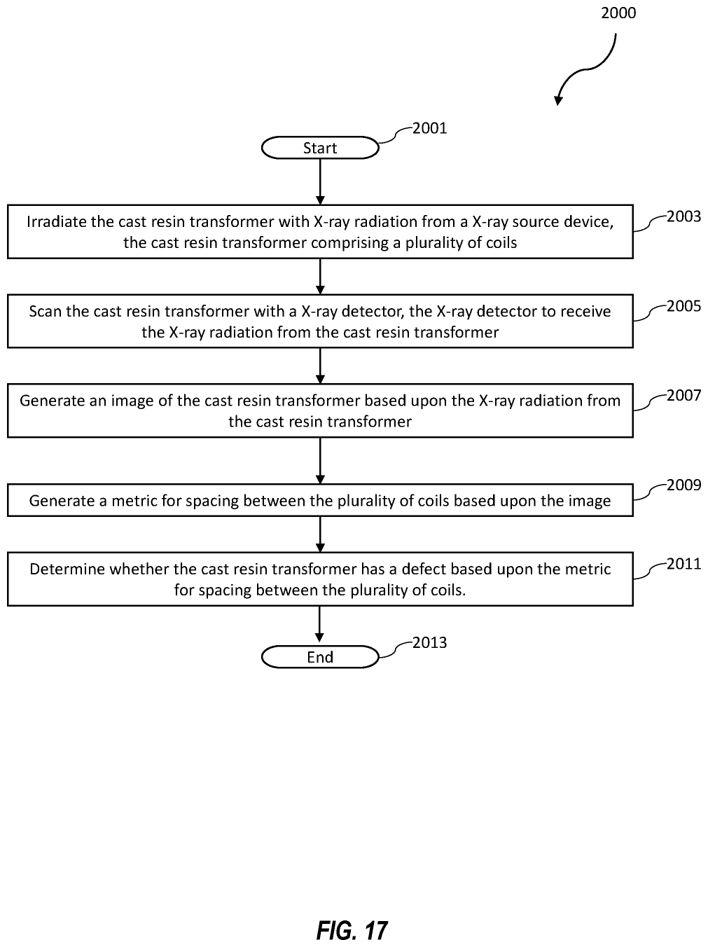

### DETAILED DESCRIPTION

The present disclosure will now be described more fully hereinafter with reference to the accompanying drawings, in which several embodiments of the invention are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout, and base 100 reference numerals are used to indicate similar elements in alternative embodiments.

It may be helpful to evaluate cast resin transformers during production. During production, the cast resin transformers is readily inspected and not-energized, providing safe and controlled environment. Moreover, if the cast resin transformer has a manufacturing defect, this may be discovered before failure occurs in the field.

X-ray detectors have wide usage in several fields. For example, X-ray imaging is ubiquitous in the medical imaging field. In some industrial applications, X-ray imaging, i.e. radiography, is used to verify the mechanical integrity and fidelity of components.

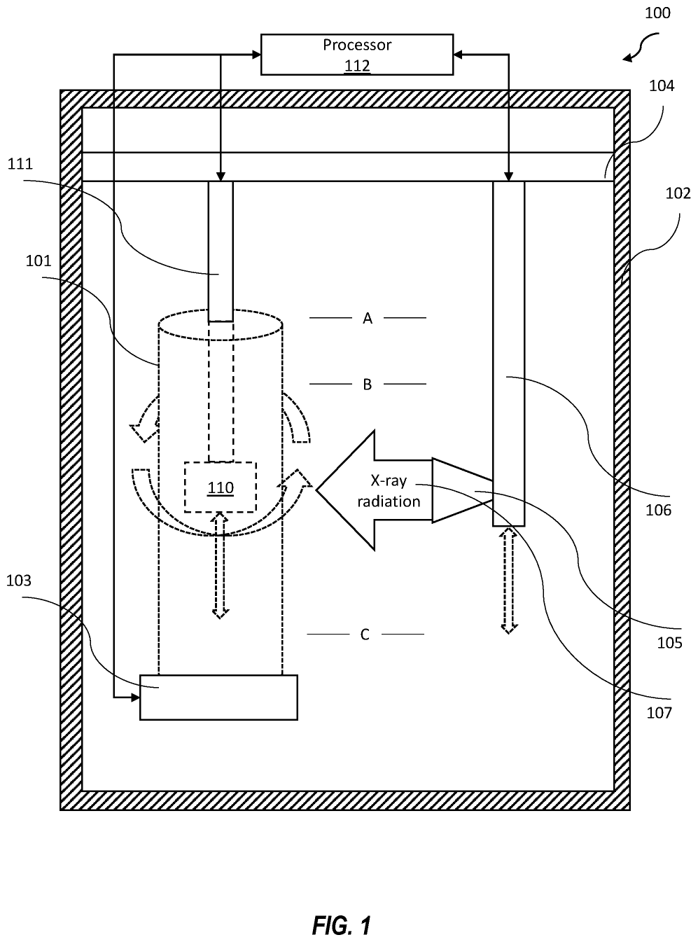

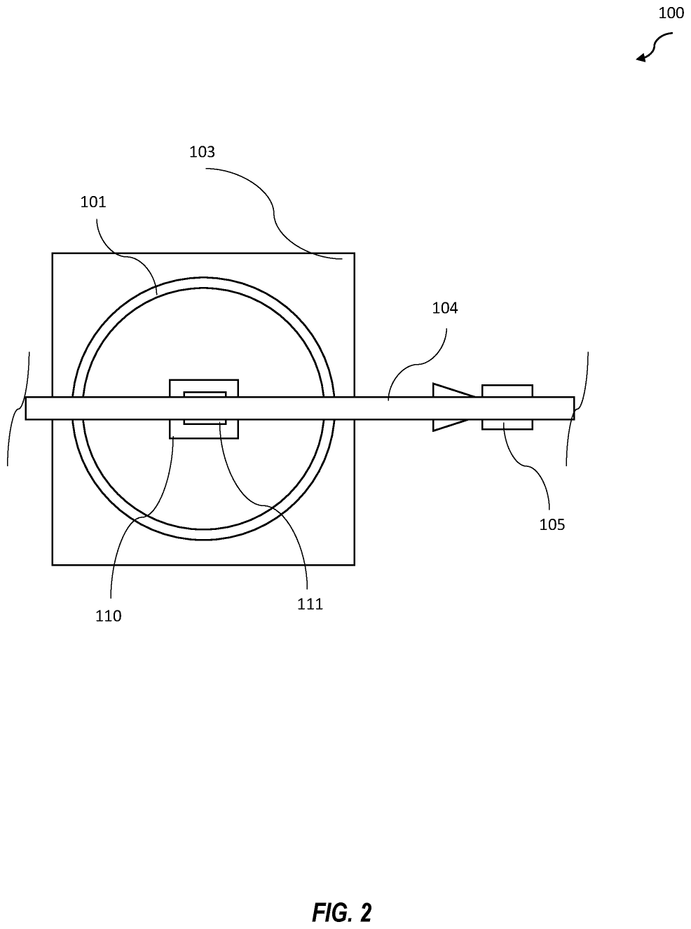

Referring initially to FIGS. 1-2, an X-ray radiation imaging system 100 according to the present disclosure is now described. The X-ray radiation imaging system 100 is for imaging a tubular object 101 (e.g. a cast resin transformer). The X-ray radiation imaging system 100 provides an approach to defect detection in cast resin transformers. Moreover, the X-ray radiation imaging system 100 performs the testing in a highly scalable and fast manner.

The X-ray radiation imaging system 100 illustratively includes an enclosure 102. As will be appreciated, the enclosure 102 may comprise one or more materials that are opaque to X-radiation, such as lead or concrete. Although the illustrated embodiment operates with X-ray radiation, other frequencies/types of radiation may be used. For example, the radiation may comprise gamma radiation, neutron radiation, beta particle radiation, proton particle radiation, and alpha particle radiation.

The X-ray radiation imaging system 100 illustratively includes a motorized base 103 to be positioned within the enclosure 102 and configured to rotate the tubular object 101. In some embodiments, the motorized base 103 comprises a platform, and a hydraulic piston under the platform for vertically elevating and rotating the tubular object 101.

The X-ray radiation imaging system 100 illustratively includes a gantry 104 within the enclosure 102. The gantry 104 may comprise a mobile gantry in some embodiments, and comprises first and second legs extending to the ground surface, and first and second casters coupled respectively to the first and second legs.

The X-ray radiation imaging system 100 illustratively includes an X-ray source 105 coupled to the gantry 104 and being adjacent the motorized base 103, and a source arm 106 coupled between the gantry and the X-ray source. The X-ray source 105 is configured to irradiate the tubular object 101 with X-ray radiation 107 while the motorized base 103 rotates the tubular object 101.

The X-ray radiation imaging system 100 illustratively comprises an X-ray detector 110 coupled to the gantry 104 and being radially within the tubular object 101, and a detector arm 111 coupled between the gantry 104 and the X-ray detector. The X-ray detector 110 receives the X-ray radiation 107 from the tubular object 101. In some embodiments, the X-ray detector 110 may comprise a line scanner X-ray detector.

The X-ray radiation imaging system 100 illustratively includes a processor 112 coupled to the X-ray source 105, the X-ray detector 110, and the motorized base 103. The processor 112 is configured to generate an image of the tubular object 101. In particular, as will be appreciated, for line scanner embodiments, the processor 112 is configured to produce an assembled image of the tubular object 101.

The processor 112 is configured to cause the detector arm 111 and the source arm 106 to respectively vertically align the X-ray detector 110 and the X-ray source 105 with respect to the tubular object 101. The detector arm 111 and the source arm 106 are configured to extend vertically and simultaneously with equal alignment while the motorized base 103 rotates the tubular object 101. For example, as illustrated in FIG. 1, the detector arm 111 and the source arm 106 are configured to image the tubular object 101 at three discrete levels A, B, C.

In applications where the tubular object 101 is a cast resin transformer, the processor 112 is configured to process the assembled image of the tubular object 101 to evaluate spacing in the plurality of coils in the cast resin transformer. The processor 112 is configured to generate a metric for spacing between the plurality of coils based upon the assembled image. The generating of the metric comprises generating a plurality of spacing values for the plurality of coils of the cast resin transformer 101, and determining a distribution of the plurality of spacing values. In some embodiments, the generating of the plurality of spacing values for the plurality of coils of the cast resin transformer 101 may comprise edge detection processing.

The processor 112 is configured to determine whether the cast resin transformer 101 has a defect based upon the metric for spacing between the plurality of coils. In particular, the metric for spacing between the plurality of coils is based upon the distribution of values. In this instance, the metric represents the percentage of coils outside first or second standard deviation of the distribution. In short, the metric flags spacing outliers, which would be indicative of a manufacturing defect.

Another aspect is directed to a method for making an X-ray radiation imaging system 100 for imaging a tubular object 101. The method includes positioning a motorized base 103 within an enclosure 102 and configured to rotate the tubular object 101, positioning a gantry 104 within the enclosure, and coupling at least one X-ray source 105 to the gantry and being adjacent the motorized base. The at least one X-ray source 105 is configured to irradiate the tubular object 101 with X-ray radiation 107 while the motorized base 103 rotates the tubular object. The method comprises coupling at least one X-ray detector 110 to the gantry 104 and being adjacent the tubular object 101, the at least one X-ray detector to receive the X-ray radiation 107 from the tubular object, and coupling a processor 112 to the at least one X-ray source 105 and the at least one X-ray detector and to generate an image of the tubular object.

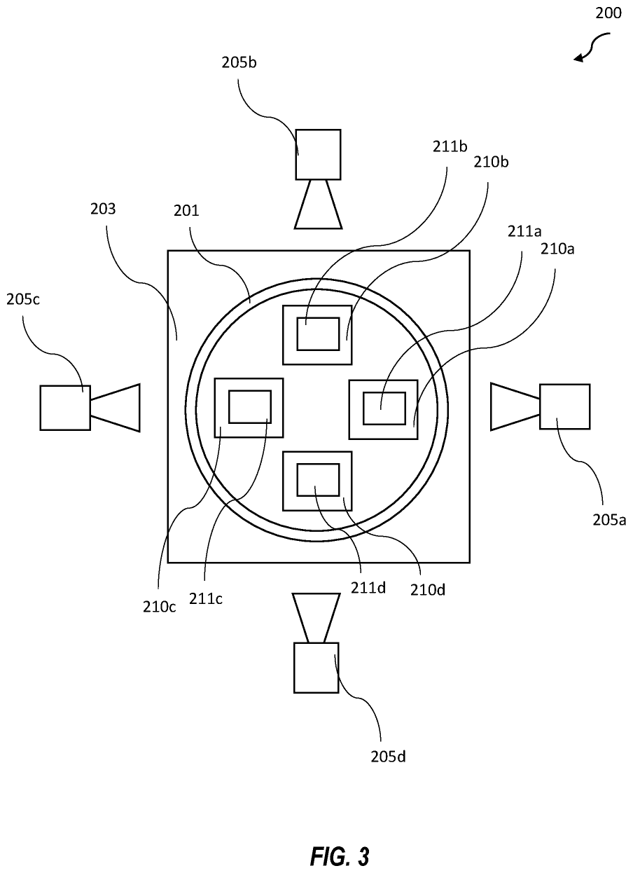

Referring now additionally to FIG. 3, another embodiment of the X-ray radiation imaging system 200 is now described. In this embodiment of the X-ray radiation imaging system 200, those elements already discussed above with respect to FIGS. 1-2 are incremented by 100 and most require no further discussion herein. This embodiment differs from the previous embodiment in that this X-ray radiation imaging system 200 illustratively includes a plurality of X-ray detectors 210a-210d spaced annularly with respect to the tubular object 201, and a plurality of X-ray sources 205a-205d spaced annularly with respect to the tubular object 201 and respectively radially opposite the plurality of X-ray detectors.

In this embodiment, the plurality of X-ray detectors 210a-210d is positioned within the tubular object 201 and angularly spaced at 90°. The plurality of X-ray sources 205a-205d is positioned outside the tubular object 201 and angularly spaced at 90° in alignment with the plurality of X-ray detectors 210a-210d. Of course, the angular spacing is exemplary, the number of the plurality of X-ray detectors 210a-210d and the plurality of X-ray sources 205a-205d may be varied, which will change the angular spacing respectively. As will be appreciated, this embodiment may scan the tubular object 201 with a minimal 90° rotation, which increases the speed of the scanning.

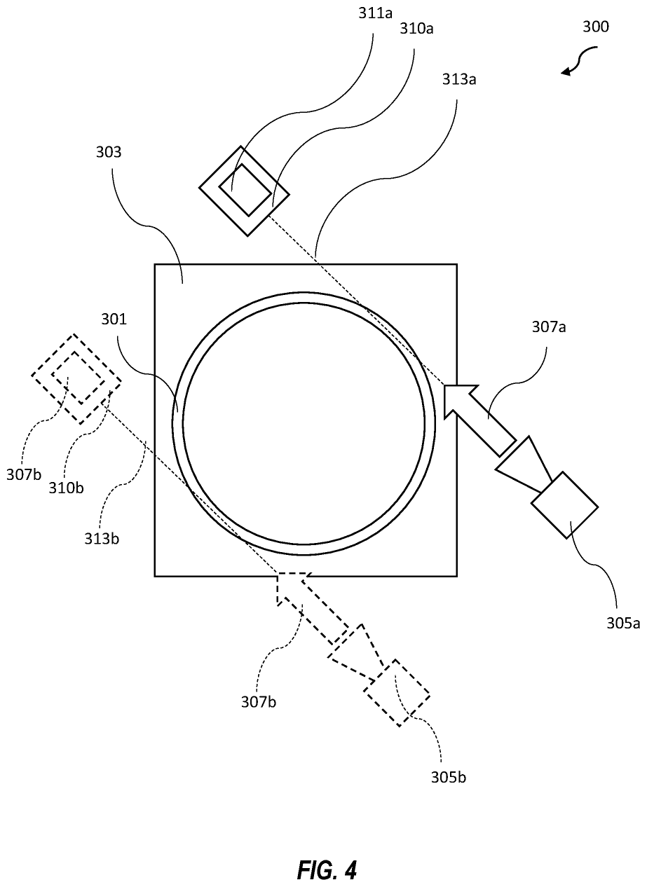

Referring now additionally to FIG. 4, another embodiment of the X-ray radiation imaging system 300 is now described. In this embodiment of the X-ray radiation imaging system 300, those elements already discussed above with respect to FIGS. 1-2 are incremented by 200 and most require no further discussion herein. This embodiment differs from the previous embodiment in that this X-ray radiation imaging system 300 illustratively includes an X-ray detector 310a and an X-ray source 305a aligned along a tangential line 313a of the tubular object 301.

Although this embodiment shows only a single X-ray detector 310a and X-ray source 305a set, in other embodiments, there may be additional X-ray detector 310b and X-ray source 305b sets (shown with dashed lines) placed at varying tangential lines 313a-313b. These embodiments would permit faster scanning of the tubular object 301. Helpfully, this embodiment may be used for the tubular object 301 when the inner diameter is less than a minimum clearance width for the X-ray detectors 310a-310b to be inserted within the tubular object.

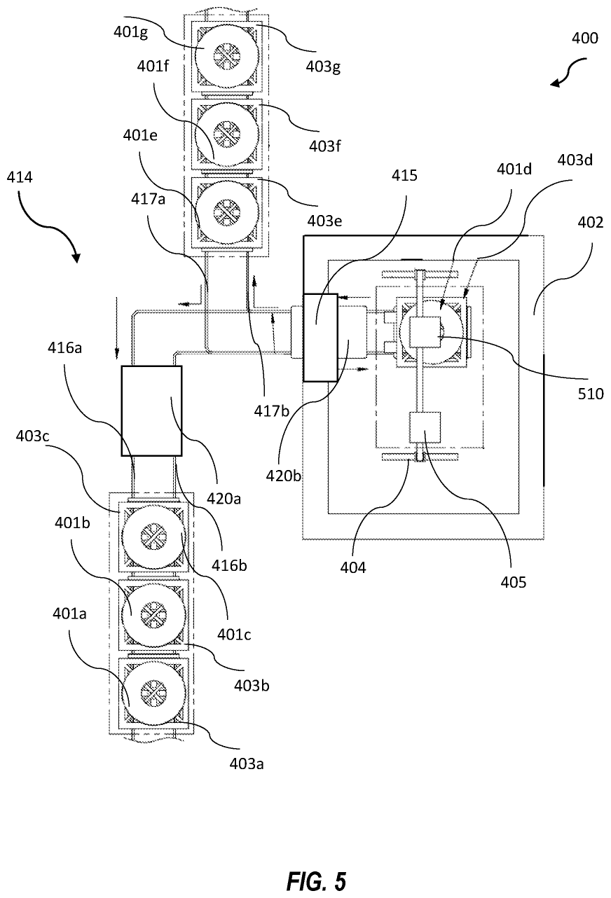

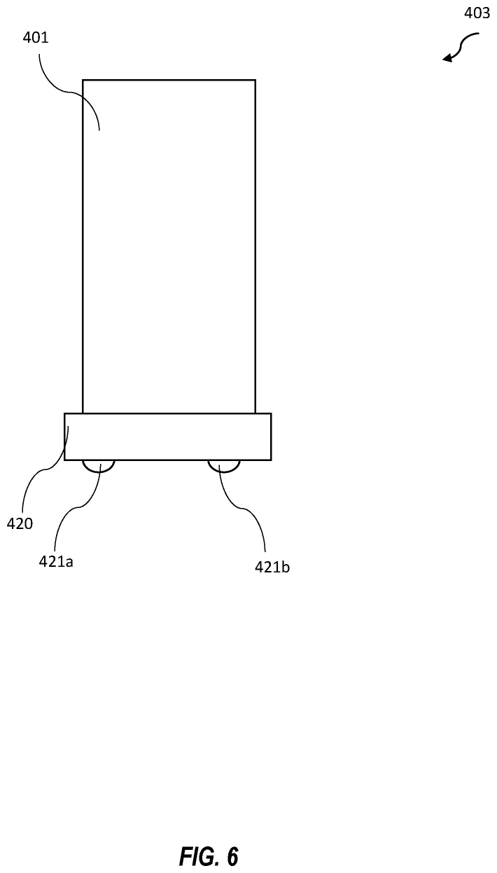

Referring now additionally to FIGS. 5-6, another embodiment of the X-ray radiation imaging system 400 is now described. In this embodiment of the X-ray radiation imaging system 400, those elements already discussed above with respect to FIGS. 1-2 are incremented by 300 and most require no further discussion herein. This embodiment differs from the previous embodiment in that this X-ray radiation imaging system 400 illustratively includes a conveyor 414 extending through the enclosure 402 and to position the tubular object 401 on the motorized base 403. Here, the enclosure 402 illustratively includes a door 415, and the conveyor 414 extends through the door.

As perhaps best seen in FIG. 5, the conveyor 414 illustratively comprises a first set of rails 416a-416b extending from a queue of uninspected tubular objects 401a-401d and through the door 415. The conveyor 414 illustratively comprises a second set of rails 417a-417b extending through the door 415 and to a queue of inspected tubular objects 401e-401g.

As perhaps best seen in FIG. 6, the motorized base 403a-403b comprises an AGV. In this illustrated embodiment, the X-ray radiation imaging system 400 illustratively includes first and second motorized bases 403a-403b for carrying the tubular objects from the queue of uninspected tubular objects 401a-401d to the enclosure 402 and then to the queue of inspected tubular objects 401e-401g. Each of the first and second motorized bases 403a-403b comprises a base 420, a set of wheels 421a-421b coupled to the base, one or more motors driving the set of wheels, and circuitry configured to control motion of the one or more motors. Also, the door 415 is closable and controlled automatically to permit movement of the first and second motorized bases 403a-403b.

In this embodiment, the first and second motorized bases 403a-403b are responsible for translational movement along the first set of rails 416a-416b and the second set of rails 417a-417b and for the rotational movement of the tubular object 401a-401g during the scan. Helpfully, the X-ray radiation imaging system 400 may provide for automatic and easy testing of the tubular objects 401a-401g without user intervention. Of course, in other embodiments, the movement of the tubular objects 401a-401g may be done manually, or with other equipment, such as a fork lift.

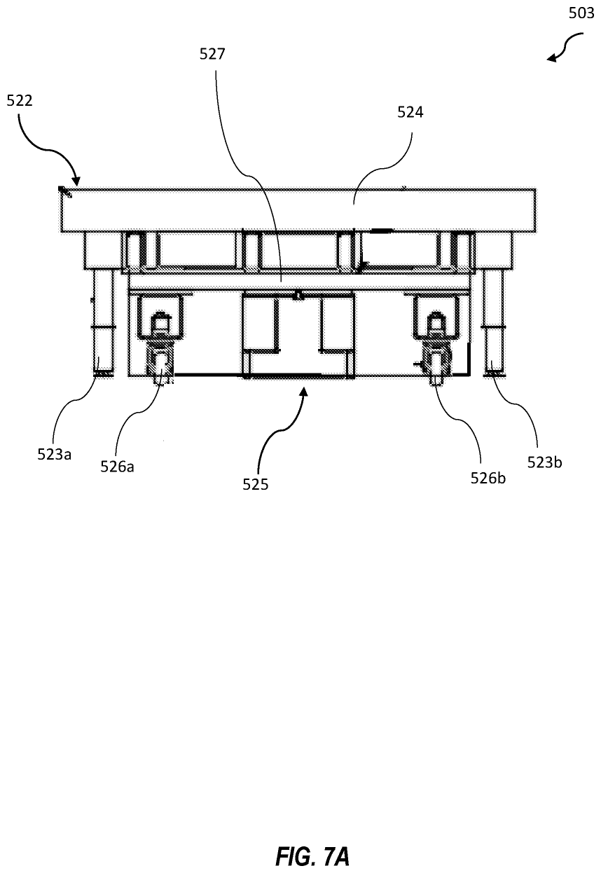

Referring now additionally to FIGS. 7A-7B, another embodiment of the motorized base 503 is now described. In this embodiment of the motorized base 503, those elements already discussed above with respect to FIGS. 1-2 are incremented by 400 and most require no further discussion herein. This embodiment differs from the previous embodiment in that this motorized base 503 illustratively includes a first vertical left mechanism 522 comprising first and second vertical lift legs 523a-523b, and a first base 524 coupled to the first and second vertical lift legs. As shown in FIG. 7B, the first and second vertical lift legs 523a-523b adjust the height of the first base 524.

The motorized base 503 illustratively includes a second mechanism 525 for rotational and translation movement. The second mechanism 525 illustratively comprises first and second casters 526a-526b, and a second base 527 coupled to the first and second casters.

The motorized base 503 can be used in embodiments of the X-ray radiation imaging system 400 with the conveyor 414, such as depicted in FIGS. 5-6. In such an application, the second mechanism 525 would move the tubular objects 401a-401g to and from the enclosure 402, and the first vertical left mechanism 522 would remain stationary within the enclosure. In particular, for a tubular object 401a-401g under test, the second mechanism 525 would retrieve and place the tubular object onto the first vertical left mechanism 522. Alternatively, the first vertical left mechanism 522 could remain stationary outside the enclosure, one being adjacent the queue of untested tubular objects 401a-401g and another being adjacent the queue of tested tubular objects 401a-401g. The first vertical left mechanism 522 would enable easy loading and unloading of the tubular objects 401a-401g.

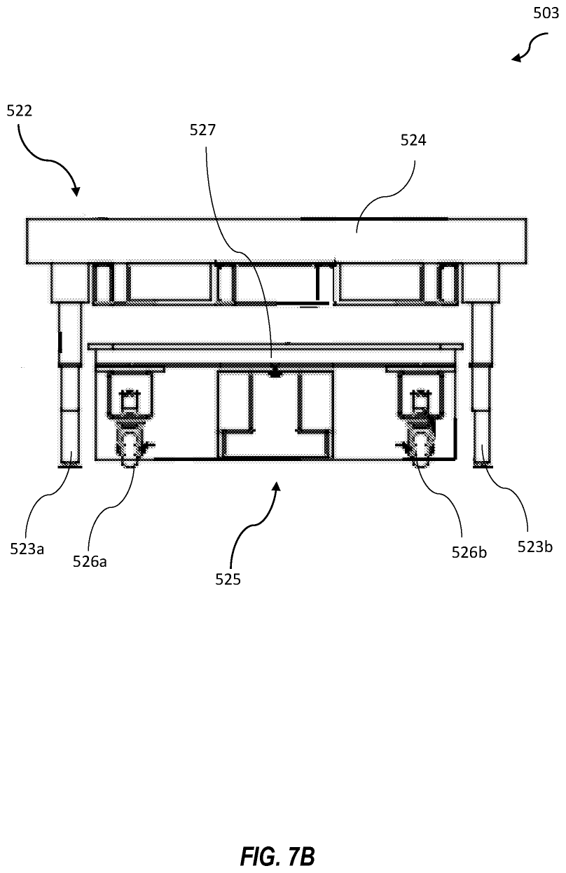

Referring now additionally to FIG. 8, another embodiment of the X-ray radiation imaging system 600 is now described. In this embodiment of the X-ray radiation imaging system 600, those elements already discussed above with respect to FIGS. 1-2 are incremented by 500 and most require no further discussion herein. This embodiment differs from the previous embodiment in that this X-ray radiation imaging system 600 illustratively includes an enclosure 602 having first and second doors 615a-615b. Also, the conveyor 614 illustratively includes three paths. The first path 616a-616b is from the queue of the untested tubular objects 601a-601c to the enclosure 602, and the second path 617a-617b is from the enclosure 602 to the queue of tested tubular objects 601g-601i. The third path 630a-630b is from the queue of tested tubular objects 601g-601i to the queue of the untested tubular objects 601a-601c.

During typical operation of the X-ray radiation imaging system 600, the motorized base 603d is transiting a respective tubular object 601d to the enclosure 602 for testing. Simultaneously, the motorized base 603e is positioning and rotating a respective tubular object 601e for testing, and another motorized base 603f is transiting a respective tubular object 601f from testing to the storage of the tested tubular objects 601g-601i. Also, the motorized base 603j without any load is transiting to a loading station 631, where an untested tubular object is loaded thereon. Once loaded, the motorized base 603j is transiting to the queue of the untested tubular objects 601a-601c.

Advantageously, this embodiment of the X-ray radiation imaging system 600 is able to process and test a large number of tubular objects 601a-601i quickly. Indeed, for applications where the tubular object 601a-601i comprises a cast resin transformer, this is helpful due to the scale of manufacturing.

Generally, an X-ray radiation imaging system is for imaging an object. The X-ray radiation imaging system may include an X-ray source device configured to irradiate the object with X-ray radiation, an X-ray detector to be positioned adjacent the object and comprising at least one flexible carrier layer, and a plurality of X-ray sensing segments carried by the at least one flexible carrier layer and defining a sensing array. The plurality of X-ray sensing segments may receive the X-ray radiation from the object. The X-ray radiation imaging system may include a processor coupled to the X-ray source device and the X-ray detector and configured to generate an image of the object.

In some embodiments, the sensing array may comprise a rectangle-shaped array. Each X-ray sensing segment may comprise an X-ray phosphor plate, and a transceiver coupled to the X-ray phosphor plate and configured to transmit to the processor. Each X-ray sensing segment in the sensing array may comprise an identifier opaque to the X-ray radiation from the object, and the processor may be configured to generate the image of the object based upon a known position of respective identifiers in the sensing array.

The X-ray detector may comprise an arm coupled to the at least one flexible carrier layer, and the arm may extend transverse to the at least one flexible carrier layer and to engage the object. For example, the arm may comprise a clamp device.

In other embodiments, the at least one flexible carrier layer may comprise a plurality of flexible carrier layers, and a plurality of fasteners coupling the plurality of flexible carrier layers together. The plurality of flexible carrier layers may be arranged in a three-dimensional shape.

Moreover, the X-ray source device may comprise an X-ray source, and a platform carrying the X-ray source. The platform may be configured to position the X-ray source to irradiate the object based upon the sensing array.

Another aspect is directed to a method for X-ray radiation imaging of a cast resin transformer. The method may include positioning an X-ray detector within the cast resin transformer. The X-ray detector may comprise at least one flexible carrier layer, and a plurality of X-ray sensing segments carried by the at least one flexible carrier layer and defining a sensing array. The method may include positioning an X-ray source device to irradiate the cast resin transformer with X-ray radiation. The plurality of X-ray sensing segments may receive the X-ray radiation from the cast resin transformer. The method may further include generating an image of the cast resin transformer based upon the plurality of X-ray sensing segments.

Yet another aspect is directed to a method for detecting a defect in a cast resin transformer. The method may include irradiating the cast resin transformer with X-ray radiation from an X-ray source device. The cast resin transformer may include a plurality of coils. The method may comprise scanning the cast resin transformer with an X-ray detector, the X-ray detector to receive the X-ray radiation from the cast resin transformer, and generating an image of the cast resin transformer based upon the X-ray radiation from the cast resin transformer. The method may comprise generating a metric for spacing between the plurality of coils based upon the image, and determining whether the cast resin transformer has a defect based upon the metric for spacing between the plurality of coils.

Also, the generating of the metric may comprise generating a plurality of spacing values for the plurality of coils of the cast resin transformer, and determining a distribution of the plurality of spacing values. The generating of the plurality of spacing values for the plurality of coils of the cast resin transformer may comprise edge detection processing.

It may be helpful to evaluate cast resin transformers in the field. In particular, cast resin transformers may be subject to damage during use (e.g. due to improper voltage, or structure fatigue), and it may be helpful to evaluate cast resin transformers on a regular basis to determine whether replacement is needed. Moreover, if the cast resin transformer has a manufacturing defect, this may be discovered before failure occurs in the field. Given their upstream placement in the power transmission system, it is desirable to reduce the risk of failure.

X-ray detectors have wide usage in several fields. For example, X-ray imaging is ubiquitous in the medical imaging field. In some industrial applications, X-ray imaging, i.e. radiography, is used to verify the mechanical integrity and fidelity of components. Nevertheless, the use of X-ray imaging for cast resin is impractical for at least a couple of reasons. First, outdoor mobile X-ray imaging is difficult. X-ray sensing equipment is generally sensitive to environmental conditions. Moreover, it may be impossible to scan a cast resin transformer while installed. Indeed, the tubular structure is generally filled with additional electronics on the inside. Lastly, typical X-ray imaging would cause potential damage to the cast resin transformer during removal and reinstallation.

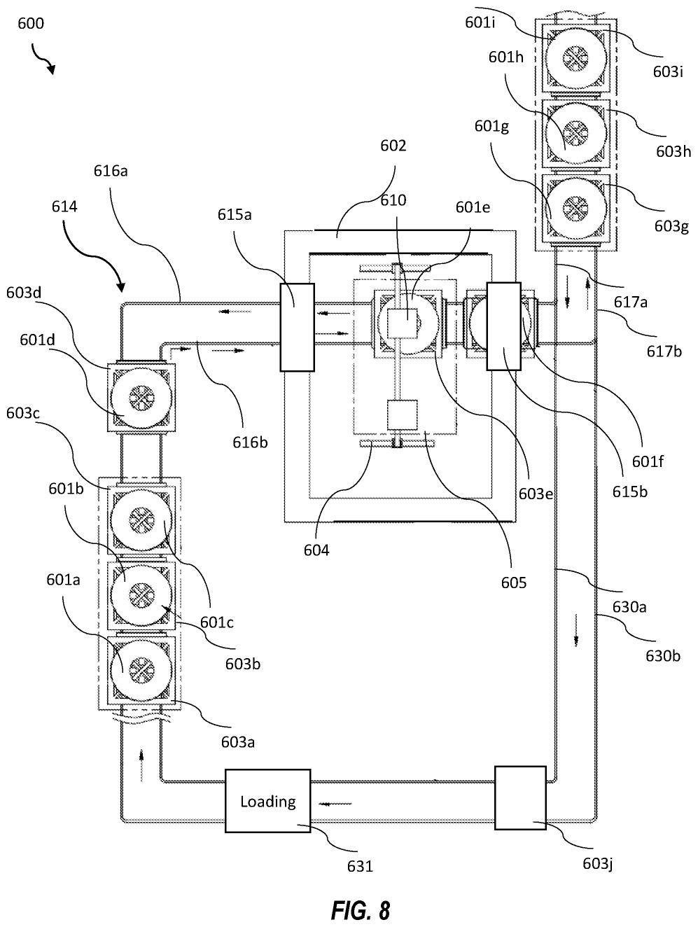

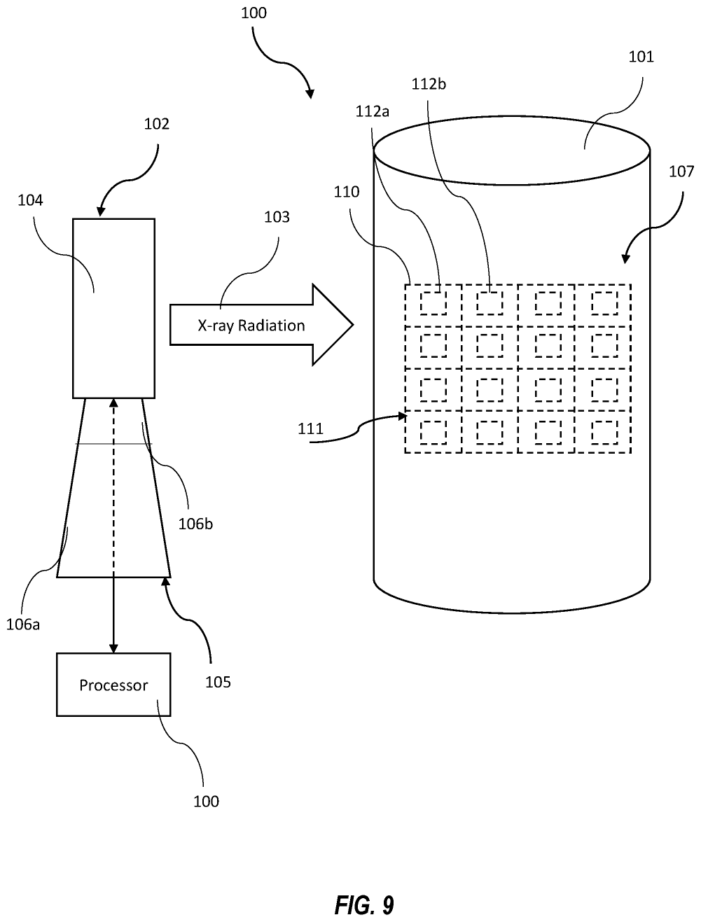

Referring now to FIGS. 9-10, an X-ray radiation imaging system 100 according to the present disclosure is now described. The X-ray radiation imaging system 100 is for imaging an object 101. For example, the object 101 may comprise a tubular structure, such as a cast resin transformer. The X-ray radiation imaging system 100 illustratively includes an X-ray source device 102 configured to irradiate the object with X-ray radiation 103. Moreover, the X-ray source device 102 illustratively includes an X-ray source 104, and a platform 105 carrying the X-ray source. The platform 105 is configured to position the X-ray source to irradiate the object 101. In particular, the platform 105 comprises multi-leg base 106a for placement on a ground surface/floor, and a telescoping upper end 106b for vertically positioning the X-ray source 104. The telescoping upper end 106b may comprise a pair of sliding concentric tubes permitting longitudinal extension and retraction thereof, and a locking device (e.g. transverse push pin or screw) for locking a longitudinal position. Also, the telescoping upper end 106b is configured to permit rotational positioning to properly irradiate the object 101.

The X-ray radiation imaging system 100 illustratively includes an X-ray detector 107 to be positioned adjacent the object 101. In particular, for applications where the object 101 comprises a cast resin transformer, the X-ray detector 107 is inserted into an interior of the transformer.

Although the illustrated embodiment operates with X-ray radiation, other frequencies/types of radiation may be used. For example, the radiation may comprise gamma radiation, neutron radiation, beta particle radiation, proton particle radiation, and alpha particle radiation.

The X-ray detector 107 illustratively includes a flexible carrier layer 110 (i.e. able to take on curved shapes), and a plurality of X-ray sensing segments 112a-112n carried by the flexible carrier layer and defining a sensing array 111. Helpfully, the flexible nature of the X-ray detector 107 permits it to be readily inserted into the object 101, for example, the cast resin transformer.

The plurality of X-ray sensing segments 112a-112n may be coupled to the flexible carrier layer 110 via any suitable mechanical method. In some embodiments, each X-ray sensing segments 112a-112n comprises an adhesive layer for coupling to the flexible carrier layer 110. In other embodiments, the flexible carrier layer 110 comprises a plurality of pockets/recesses (e.g. closable pockets) for respectively receiving the plurality of X-ray sensing segments 112a-112n. In yet other embodiments, a hook and loop interface between the flexible carrier layer 110 and the plurality of X-ray sensing segments 112a-112n may be used. In some embodiments, the flexible carrier layer 110 comprises a plurality of openings defining the sensing array 111, and each X-ray sensing segment 112a-112n has an arm to be inserted within a respective opening.

The platform 105 is configured to position the X-ray source 104 to irradiate the object 101 based upon the sensing array 111. In particular, the X-ray radiation 103 is desirably substantially (i.e. each X-ray sensing segments 112a-112n receiving an amount of radiation being ±5% within a mean radiation value) evenly distributed across the sensing array 111.

In the illustrated embodiments, the sensing array 111 comprises a rectangle-shaped array, for example, the 4×4 array shown in FIG. 9. It should be appreciated that this is an exemplary size, and other array shapes and sizes are possible. Indeed, in some embodiments, a single column array may be used, such as a 1×8 array. These single column embodiments would be advantageous for difficult imaging applications where there is little room for insertion of the X-ray detector 107.

The plurality of X-ray sensing segments 112a-112n are to receive the X-ray radiation 103 from the object 101. As will be appreciated, the object 101 will scatter the X-ray radiation 103, which will be received by the X-ray detector 107. The X-ray radiation imaging system 100 illustratively comprises a processor 113 coupled to the X-ray source device 102 and the X-ray detector 107 and configured to generate an image of the object 101. In some embodiments, the telescoping upper end 106b comprises one or more electric motors for actuating longitudinal extension and rotational movement thereof, and the processor 113 is configured to cause the one or more electric motors to position the X-ray source 104 to irradiate the object 101 automatically and without user intervention.

As perhaps best seen in FIG. 10, each X-ray sensing segment 112a-112n illustratively comprises an X-ray phosphor plate 114 configured to generate an image of the X-ray radiation 103 received by the phosphor plate. Also, each X-ray sensing segment 112a-112n includes a wireless transceiver 115 and associated antenna 118 coupled to the X-ray phosphor plate 114 and configured to transmit to the image of the X-ray radiation 103 received by the phosphor plate to the processor 113. In other embodiments, each X-ray sensing segment 112a-112n includes a wired transceiver, and associated wiring for coupling to the processor 113.

Each X-ray sensing segment 112a-112n in the sensing array 111 illustratively comprises an identifier 116 opaque to the X-ray radiation 103 from the object 101. In some embodiments, the identifier 116 is a marker (e.g. identification string, geometric pattern of holes) visible in image of the X-ray radiation 103. The processor 113 is configured to generate the image of the object 101 based upon a known position of respective identifiers in the sensing array 111. In other words, the processor 113 is configured to assemble or stitch together the image of the X-ray radiation 103 received by the phosphor plates 114 into an assembled image of the object 101. In applications where the object 101 comprises a cast resin transformer comprising a plurality of coils, the assembled image depicts the spacing and position of the plurality of coils.

In other embodiments, each X-ray sensing segment 112a-112n comprises an X-ray film segment. In these embodiments, the X-ray film segments are subsequently developed and digitally scanned for ingestion by the processor 113.

Also, the X-ray detector 107 comprises a plurality of fasteners carried by the flexible carrier layer 110 and for fixing the flexible carrier layer to the object 101. For example, each fastener may comprise an adhesive strip layer, or a mechanical coupling, such as a spring loaded clamp.

In a typical application where the object 101 comprises a cast resin transformer, the process for imaging and inspecting the cast resin transformer is as follows. The cast resin transformer may be depowered for this process, but may remain installed. The X-ray detector 107 is then inserted into the cast resin transformer. More specifically, the X-ray detector 107 is inserted between the resin tubular wall and the internal electronics, and the fastener is coupled to the resin tubular wall. Once the X-ray detector 107 is positioned, the X-ray source device 102 is positioned to irradiate the cast resin transformer. The processor 113 is configured to receive a plurality of images from the plurality of X-ray sensing segments 112a-112n, and subsequently assemble the plurality of images into an image of the cast resin transformer.

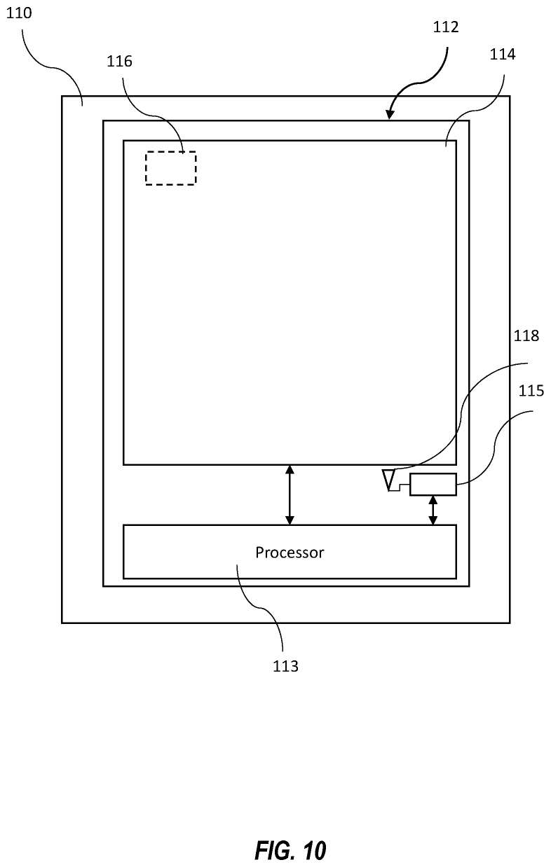

Referring now additionally to FIG. 11, generally, a method for X-ray radiation imaging of a cast resin transformer 101 is now described with a flowchart 1000. (Block 1001). The method includes positioning an X-ray detector 107 within the cast resin transformer 101. (Block 1003). The X-ray detector 107 comprises at least one flexible carrier layer 110, and a plurality of X-ray sensing segments 112a-112n carried by the at least one flexible carrier layer and defining a sensing array 111. The method includes positioning an X-ray source device 102 to irradiate the cast resin transformer 101 with X-ray radiation 103. (Block 1005). The plurality of X-ray sensing segments 112a-112n is to receive the X-ray radiation 103 from the cast resin transformer 101. The method further comprises generating an image of the cast resin transformer 101 based upon the plurality of X-ray sensing segments 112a-112n. (Blocks 1007, 1009).

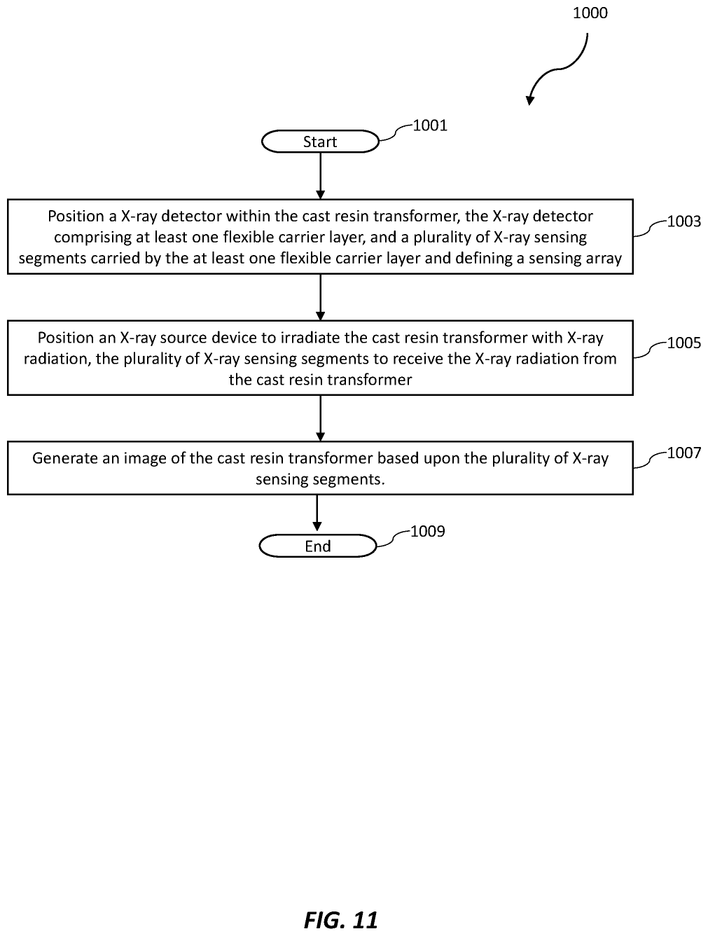

Referring now additionally to FIG. 12, another embodiment of the X-ray detector 207 is now described. In this embodiment of the X-ray detector 207, those elements already discussed above with respect to FIGS. 9-11 are incremented by 100 and most require no further discussion herein. This embodiment differs from the previous embodiment in that this X-ray detector 207 includes a flexible carrier layer 210, and a plurality of X-ray sensing segments 212a-212n carried by the flexible carrier layer and defining a sensing array 211. Here, the X-ray detector 207 illustratively includes first and second fastener strips 217a-217b carried by the flexible carrier layer 210 respectively at first and second opposing sides of the flexible carrier layer.

In some embodiments, the first and second fastener strips 217a-217b each comprises an adhesive layer for coupling to the object. In other embodiments, the first and second fastener strips 217a-217b comprises hook and loop fasteners, or other mechanical fasteners (e.g. spring loaded clamp).

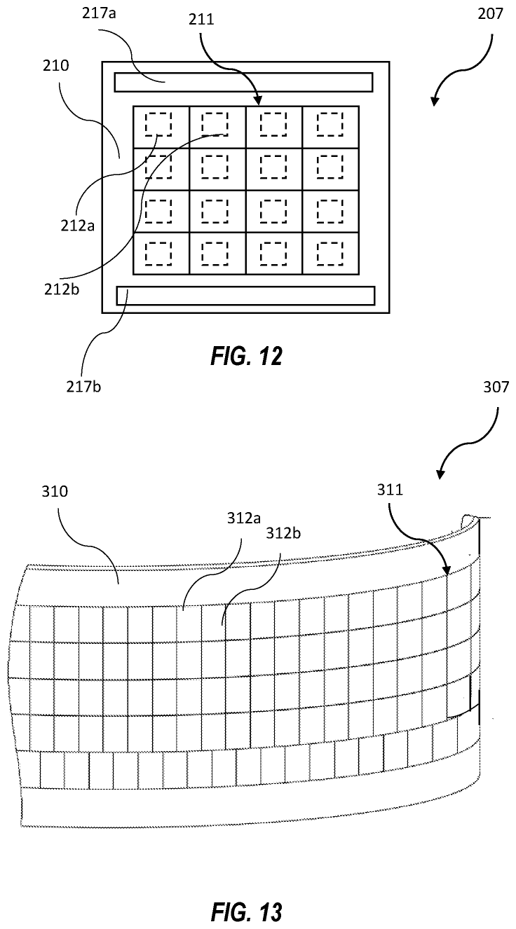

Referring now additionally to FIG. 13, another embodiment of the X-ray detector 307 is now described. In this embodiment of the X-ray detector 307, those elements already discussed above with respect to FIGS. 9-11 are incremented by 200 and most require no further discussion herein. This embodiment differs from the previous embodiment in that this X-ray detector 307 includes a flexible carrier layer 310, and a sensing array 311 carried by the flexible carrier layer. Here, the flexible carrier layer 310 is in a non-planar shape, for example, the illustrated curved surface. As will be appreciated, this enables the X-ray detector 307 to be readily inserted into the arcuate space of a cast resin transformer.

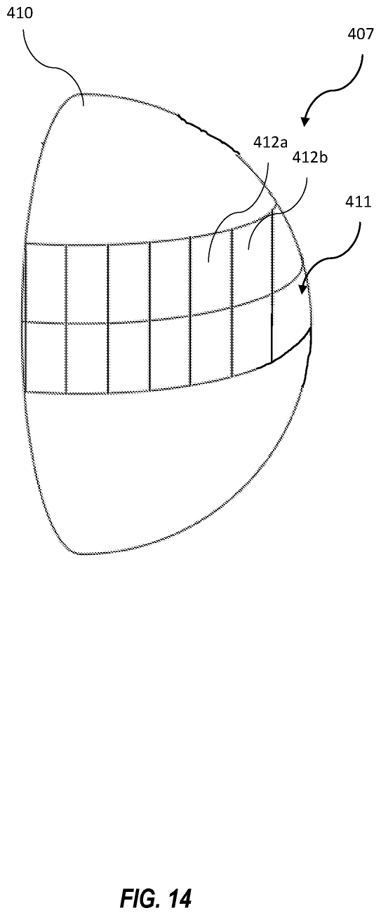

Referring now additionally to FIG. 14, another embodiment of the X-ray detector 407 is now described. In this embodiment of the X-ray detector 407, those elements already discussed above with respect to FIGS. 9-11 are incremented by 300 and most require no further discussion herein. This embodiment differs from the previous embodiment in that this X-ray detector 407 includes a flexible carrier layer 410, and a sensing array 411 carried by the flexible carrier layer. Here, the flexible carrier layer 410 is in a non-planar shape, for example, the sphere-shaped surface.

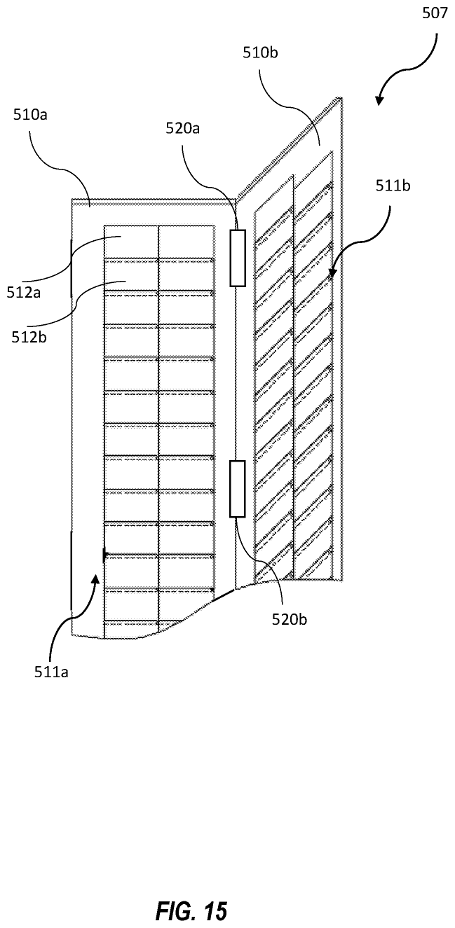

Referring now additionally to FIG. 15, another embodiment of the X-ray detector 507 is now described. In this embodiment of the X-ray detector 507, those elements already discussed above with respect to FIGS. 9-11 are incremented by 400 and most require no further discussion herein. This embodiment differs from the previous embodiment in that this X-ray detector 507 includes a plurality of flexible carrier layers 510a-510b, and a plurality of fasteners 520a-520b coupling the plurality of flexible carrier layers together. In the illustrated embodiment, the plurality of flexible carrier layers 510a-510b is arranged in a three-dimensional shape, for example, the illustrated L-shaped box.

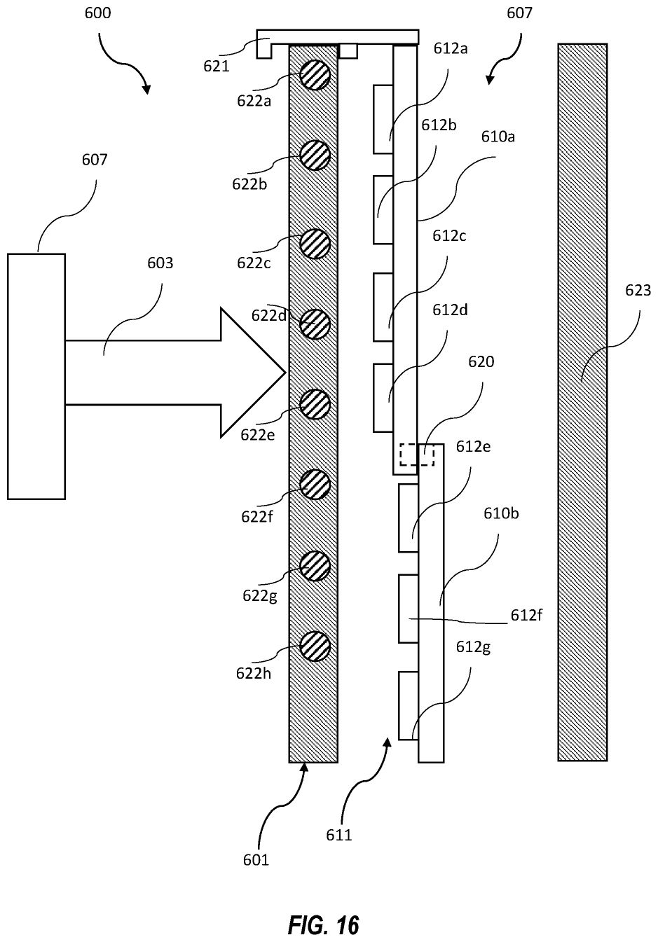

Referring now additionally to FIG. 16, another embodiment of the X-ray detector 607 is now described. In this embodiment of the X-ray detector 607, those elements already discussed above with respect to FIGS. 9-11 are incremented by 500 and most require no further discussion herein. This embodiment differs from the previous embodiment in that this X-ray detector 607 includes an upper flexible carrier layer 610a, a lower flexible carrier layer 610b, and a fastener 620 coupling the upper and lower flexible layers.

This X-ray detector 607 illustratively comprises an arm 621 coupled to an upper flexible carrier layer 610a, and the arm extends transverse to the upper flexible carrier layer and to engage (i.e. clamping an uppermost end) the cast resin transformer 601. The cast resin transformer 601 illustratively includes a plurality of coils 622a-622h. For example, the arm 621 illustratively includes a clamp device.

Here, advantageously, the X-ray detector 607 has a slim side profile, which allows for insertion between the outer tubular body of the cast resin transformer 601 and inner electronics 623. This permits for the cast resin transformer 601 to be scanned while still installed within an application.

Referring now to FIGS. 16 & 17, a method for detecting a defect in a cast resin transformer 601 is now described with a flowchart 2000. (Block 2001). The method includes irradiating the cast resin transformer 601 with X-ray radiation 603 from an X-ray source device 602. (Block 2003). The cast resin transformer 601 comprises a plurality of coils 622a-622h. The method comprises scanning the cast resin transformer 601 with an X-ray detector 607. (Block 2005). The X-ray detector 607 is to receive the X-ray radiation 603 from the cast resin transformer 601. The method comprises generating an image of the cast resin transformer 601 based upon the X-ray radiation 603 from the cast resin transformer. (Block 2007).

Moreover, the method comprises generating a metric for spacing between the plurality of coils 622a-622h based upon the image. (Block 2009). The generating of the metric comprises generating a plurality of spacing values for the plurality of coils 622a-622h of the cast resin transformer 601, and determining a distribution of the plurality of spacing values. In some embodiments, the generating of the plurality of spacing values for the plurality of coils 622a-622h of the cast resin transformer 601 may comprise edge detection processing.

The method further comprises determining whether the cast resin transformer 101 has a defect based upon the metric for spacing between the plurality of coils 622a-622h. (Blocks 2011, 2013). In particular, the metric for spacing between the plurality of coils 622a-622h is based upon the distribution of values. In this instance, the metric represents the percentage of coils outside first or second standard deviation of the distribution. In short, the metric flags spacing outliers, which would be indicative of a manufacturing defect.

An X-ray radiation imaging system for imaging an object, the X-ray radiation imaging system comprising: an X-ray source device configured to irradiate the object with X-ray radiation; an X-ray detector to be positioned adjacent the object and comprising at least one flexible carrier layer, and a plurality of X-ray sensing segments carried by said at least one flexible carrier layer and defining a sensing array, said plurality of X-ray sensing segments to receive the X-ray radiation from the object; and a processor coupled to said X-ray source device and said X-ray detector and configured to generate an image of the object.

The X-ray radiation imaging system of claim 1 wherein said sensing array comprises a rectangle-shaped array. The X-ray radiation imaging system of claim 1 wherein each X-ray sensing segment comprises an X-ray phosphor plate, and a transceiver coupled to said X-ray phosphor plate and configured to transmit to said processor. The X-ray radiation imaging system of claim 1 wherein each X-ray sensing segment in said sensing array comprises an identifier opaque to the X-ray radiation from the object; and wherein said processor is configured to generate the image of the object based upon a known position of respective identifiers in said sensing array.

The X-ray radiation imaging system of claim 1 wherein said X-ray detector comprises an arm coupled to said at least one flexible carrier layer, said arm extending transverse to said at least one flexible carrier layer and to engage the object. The X-ray radiation imaging system of claim 5 wherein said arm comprises a clamp device. The X-ray radiation imaging system of claim 1 wherein said at least one flexible carrier layer comprises a plurality of flexible carrier layers, and a plurality of fasteners coupling said plurality of flexible carrier layers together. The X-ray radiation imaging system of claim 7 wherein said plurality of flexible carrier layers is arranged in a three-dimensional shape.

The X-ray radiation imaging system of claim 1 wherein said X-ray source device comprises an X-ray source, and a platform carrying said X-ray source; and wherein said platform is configured to position said X-ray source to irradiate the object based upon said sensing array.

An X-ray radiation imaging system for imaging a cast resin transformer, the X-ray radiation imaging system comprising: an X-ray source device configured to irradiate the cast resin transformer with X-ray radiation; an X-ray detector to be positioned within the cast resin transformer and comprising at least one curved flexible carrier layer to be coupled to the cast resin transformer, and a plurality of X-ray sensing segments carried by said at least one curved flexible carrier layer and defining sensing array, said plurality of X-ray sensing segments to receive the X-ray radiation from the cast resin transformer; and a processor coupled to said X-ray source device and said X-ray detector and configured to generate an image of the cast resin transformer.

The X-ray radiation imaging system of claim 10 wherein said sensing array comprises a rectangle-shaped array. The X-ray radiation imaging system of claim 10 wherein each X-ray sensing segment comprises an X-ray phosphor plate, and a transceiver coupled to said X-ray phosphor plate and configured to transmit to said processor. The X-ray radiation imaging system of claim 10 wherein each X-ray sensing segment in said sensing array comprises an identifier opaque to the X-ray radiation from the cast resin transformer; and wherein said processor is configured to generate the image of the cast resin transformer based upon a known position of respective identifiers in said sensing array.

The X-ray radiation imaging system of claim 10 wherein said X-ray detector comprises an arm coupled to said at least one curved flexible carrier layer, said arm extending transverse to said at least one curved flexible carrier layer and to engage the cast resin transformer. The X-ray radiation imaging system of claim 14 wherein said arm comprises a clamp device.

The X-ray radiation imaging system of claim 10 wherein said at least one curved flexible carrier layer comprises a plurality of curved flexible carrier layers, and a plurality of fasteners coupling said plurality of curved flexible carrier layers together.

A method for X-ray radiation imaging of a cast resin transformer, the method comprising: positioning an X-ray detector within the cast resin transformer, the X-ray detector comprising at least one flexible carrier layer, and a plurality of X-ray sensing segments carried by the at least one flexible carrier layer and defining a sensing array; positioning an X-ray source device to irradiate the cast resin transformer with X-ray radiation, the plurality of X-ray sensing segments to receive the X-ray radiation from the cast resin transformer; and generating an image of the cast resin transformer based upon the plurality of X-ray sensing segments.

The method of claim 17 wherein the sensing array comprises a rectangle-shaped array. The method of claim 17 wherein each X-ray sensing segment comprises an X-ray phosphor plate, and a transceiver coupled to the X-ray phosphor plate and configured to transmit. The method of claim 17 wherein each X-ray sensing segment in the sensing array comprises an identifier opaque to the X-ray radiation from the cast resin transformer; and further comprising generating the image of the cast resin transformer based upon a known position of respective identifiers in the sensing array.

The method of claim 17 wherein the X-ray detector comprises an arm coupled to the at least one flexible carrier layer, the arm extending transverse to the at least one flexible carrier layer and to engage the cast resin transformer.

A method for detecting a defect in a cast resin transformer, the method comprising: irradiating the cast resin transformer with X-ray radiation from an X-ray source device, the cast resin transformer comprising a plurality of coils; scanning the cast resin transformer with an X-ray detector, the X-ray detector to receive the X-ray radiation from the cast resin transformer; generating an image of the cast resin transformer based upon the X-ray radiation from the cast resin transformer; generating a metric for spacing between the plurality of coils based upon the image; and determining whether the cast resin transformer has a defect based upon the metric for spacing between the plurality of coils.

The method of claim 22 wherein the generating of the metric comprises: generating a plurality of spacing values for the plurality of coils of the cast resin transformer; and determining a distribution of the plurality of spacing values. The method of claim 23 wherein the generating of the plurality of spacing values for the plurality of coils of the cast resin transformer comprises edge detection processing.

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

1. An X-ray radiation imaging system for imaging a tubular object, the X-ray radiation imaging system comprising:
an enclosure;
a motorized base to be positioned within said enclosure and configured to rotate the tubular object;
a gantry within said enclosure;
at least one X-ray source coupled to said gantry and being adjacent said motorized base, said at least one X-ray source configured to irradiate the tubular object with X-ray radiation while said motorized base rotates the tubular object;
at least one X-ray detector coupled to said gantry and being adjacent the tubular object, said at least one X-ray detector to receive the X-ray radiation from the tubular object; and
a processor coupled to said at least one X-ray source and said at least one X-ray detector and configured to generate an image of the tubular object.

2. The X-ray radiation imaging system of claim 1 further comprising:
at least one detector arm coupled between said gantry and said at least one X-ray detector; and
at least one source arm coupled between said gantry and said at least one X-ray source;
wherein said processor is configured to cause said at least one detector arm and said at least one source arm to respectively align said at least one X-ray detector and said at least one X-ray source with respect to the tubular object.

3. The X-ray radiation imaging system of claim 2 wherein said at least one detector arm and said at least one source arm are configured to extend vertically and simultaneously with equal alignment.

4. The X-ray radiation imaging system of claim 1 wherein said at least one X-ray detector comprises a plurality of X-ray detectors spaced annularly with respect to the tubular object; and wherein said at least one X-ray source comprises a plurality of X-ray sources spaced annularly with respect to the tubular object and respectively opposite said plurality of X-ray detectors.

5. The X-ray radiation imaging system of claim 1 wherein said at least one X-ray detector and said at least one X-ray source are aligned along a tangent of the tubular object.

6. The X-ray radiation imaging system of claim 1 wherein said at least one X-ray detector comprises a line scanner X-ray detector.

7. The X-ray radiation imaging system of claim 1 further comprising a conveyor extending through said enclosure and to position the tubular object on said motorized base.

8. The X-ray radiation imaging system of claim 1 wherein said enclosure is opaque to X-ray radiation.

9. The X-ray radiation imaging system of claim 1 wherein said motorized base comprises an automated guided trolley (AGV).

10. An X-ray radiation imaging system for imaging a cast resin transformer, the X-ray radiation imaging system comprising:
an enclosure;
a motorized base to be positioned within said enclosure and configured to rotate the cast resin transformer;
a gantry within said enclosure;
at least one X-ray source coupled to said gantry and being adjacent said motorized base, said at least one X-ray source configured to irradiate the cast resin transformer with X-ray radiation while said motorized base rotates the cast resin transformer;
at least one source arm coupled between said gantry and said at least one X-ray source;
at least one X-ray detector coupled to said gantry and being adjacent the cast resin transformer, said at least one X-ray detector to receive the X-ray radiation from the cast resin transformer;
at least one detector arm coupled between said gantry and said at least one X-ray detector; and
a processor coupled to said at least one X-ray source and said at least one X-ray detector and configured to
cause said at least one detector arm and said at least one source arm to respectively align said at least one X-ray detector and said at least one X-ray source with respect to the cast resin transformer, and
generate an image of the cast resin transformer.

11. The X-ray radiation imaging system of claim 10 wherein said at least one detector arm and said at least one source arm are configured to extend vertically and simultaneously with equal alignment.

12. The X-ray radiation imaging system of claim 10 wherein said at least one X-ray detector comprises a plurality of X-ray detectors spaced annularly with respect to the cast resin transformer; and wherein said at least one X-ray source comprises a plurality of X-ray sources spaced annularly with respect to the cast resin transformer and respectively opposite said plurality of X-ray detectors.

13. The X-ray radiation imaging system of claim 10 wherein said at least one X-ray detector and said at least one X-ray source are aligned along a tangent of the cast resin transformer.

14. The X-ray radiation imaging system of claim 10 wherein said at least one X-ray detector comprises a line scanner X-ray detector.

15. The X-ray radiation imaging system of claim 10 further comprising a conveyor extending through said enclosure and to position the cast resin transformer on said motorized base.

16. The X-ray radiation imaging system of claim 10 wherein said enclosure is opaque to X-ray radiation.

17. The X-ray radiation imaging system of claim 10 wherein said motorized base comprises an automated guided trolley (AGV).

18. A method for making an X-ray radiation imaging system for imaging a tubular object, the method comprising:
positioning a motorized base within an enclosure and configured to rotate the tubular object;
positioning a gantry within the enclosure;
coupling at least one X-ray source to the gantry and being adjacent the motorized base, the at least one X-ray source configured to irradiate the tubular object with X-ray radiation while the motorized base rotates the tubular object;
coupling at least one X-ray detector to the gantry and being adjacent the tubular object, the at least one X-ray detector to receive the X-ray radiation from the tubular object; and
coupling a processor to the at least one X-ray source and the at least one X-ray detector and to generate an image of the tubular object.

19. The method of claim 18 further comprising:
coupling at least one detector arm between the gantry and the at least one X-ray detector; and
coupling at least one source arm between the gantry and the at least one X-ray source;
wherein the processor is configured to cause the at least one detector arm and the at least one source arm to respectively align the at least one X-ray detector and the at least one X-ray source with respect to the tubular object.

20. The method of claim 18 wherein the at least one X-ray detector comprises a plurality of X-ray detectors spaced annularly with respect to the tubular object; and wherein the at least one X-ray source comprises a plurality of X-ray sources spaced annularly with respect to the tubular object and respectively opposite the plurality of X-ray detectors.
